(19) United States
(12) Patent Application Publication
(10) Pub. No.: US 2022/0375005 A1
(43) Pub. Date: Nov. 24, 2022

(54) PRODUCTION MANAGEMENT SYSTEM AND NON-TRANSITORY STORAGE MEDIUM STORING PRODUCTION MANAGEMENT PROGRAM

(71) Applicant: ANRITSU CORPORATION, Kanagawa (JP)

(72) Inventors: Koji KOIZUMI, Kanagawa (JP); Jyunki KAWAMATA, Kanagawa (JP)

(21) Appl. No.: 17/664,068

(22) Filed: May 19, 2022

(30) Foreign Application Priority Data
May 24, 2021 (JP) 2021-086932
May 24, 2021 (JP) 2021-086933

(51) Int. Cl. G06Q 50/04; G06Q 10/06

(52) U.S. Cl. CPC G06Q 50/04; G06Q 10/06395

(57) ABSTRACT

There is provided a production management system capable of grasping a production line device that has caused a decrease in production efficiency and notifying an operator that the production efficiency of the entirety of the production line has decreased. A production line device including a weighing device, a packaging device, an inspection device, and a caser, and a host computer are configured to communicate via a network. In a case where a predetermined event has occurred in each of the production line devices, the production line device transmits event data indicating that the event has occurred, to the host computer. In a case where the host computer determines that production efficiency has decreased, based on the received event data, the host computer specifies the production line device that has caused the decrease in the production efficiency and outputs an alarm indicating that the production efficiency has decreased.

### TECHNICAL FIELD

The present invention relates to a production management system that manages a production status on a production line for producing, for example, meat, fish, processed foods, pharmaceuticals, and the like.

### BACKGROUND ART

In a production line for producing, for example, meat, fish, processed foods, pharmaceuticals, and the like, the manufactured commodities are weighed, packaged at a predetermined weight, inspected for the presence of foreign matters, and finally inspected for the weight. The commodities determined to be non-defective by the above inspections are packed in boxes and shipped as final products.

Patent Document 1 discloses a production line including a plurality of production line devices such as a weighing machine, a packaging machine, a product inspection machine, or a boxing machine.

In such a production line, in a case where an abnormality has occurred in a sensor or the like of each device, an operator of the production line is notified of the abnormality.

### RELATED ART DOCUMENT

[Patent Document]
[Patent Document 1] JP-A-2019-147580

### DISCLOSURE OF THE INVENTION

### Problem that the Invention is to Solve

However, in a case where a plurality of production line devices operate in cooperation, and production is continued in an inefficient state that does not reach an abnormal state in which an error or an alarm occurs in any of the devices, it is difficult to grasp which device decreases efficiency.

More specifically, in a case where a plurality of production line devices operate in cooperation, particularly in a case where the devices are arranged in a series, even if minor abnormalities such as a slight deviation in operation timing and variations in the transportation of produced commodities occur in one of the devices, as long as the abnormalities are within an allowable range of each device, a situation in which no error or alarm occurs from any of the devices, and each device continues production in an inefficient state in which it is not possible to exhibit the original performance, until any device reaches an abnormal state in which an error or an alarm occurs by time passing occurs.

That is, in the cooperative device that controls the operation of the cooperative device by transmitting and receiving signals to and from other devices in front and rear of the cooperative device, the start of the operation of the cooperative device depends on the signal transmission and reception to and from other devices, and particularly, the cooperative device that starts the operation by receiving a signal input continues waiting for the signal input as long as there is no signal input. Normally, the operations of other devices in front and rear of the cooperative device by receiving an error signal or an alarm signal of the cooperative device varies depending on the device configuration of the production line. Thus, a signal indicating an abnormal state is not output until one of the cooperative devices turns into the serious abnormal state in which it is not possible to continue the operation of the cooperative device without some measures.

As described above, it is not possible for the operator of the production line to grasp that the production line continues production in the inefficient state, and naturally, it is not possible for the operator to grasp which production line device is the cause.

### Means for Solving the Problem

According to a first aspect of the present invention, there is provided a production management system that manages a production line for producing a commodity. The production management system includes a plurality of production line devices constituting the production line, and a host computer configured to communicate with the production line devices. In a case where a preset event has occurred, the production line device transmits event data indicating that the event has occurred to the host computer. In a case where the host computer determines that production efficiency of the production line has decreased, based on the received event data, the host computer specifies the production line device that has caused the decrease in the production efficiency of the production line.

With this configuration, it is determined whether the production efficiency has decreased, based on the event data transmitted from each production line device. In a case where it is determined that the production efficiency has decreased, the production line device that has caused the decrease in the production efficiency is specified. Therefore, it is possible to grasp the production line device that has caused the decrease in the production efficiency.

Further, in the production management system according to a second aspect of the present invention, in the production management system in the first aspect, in a case where the production line device transmits a stop request, as the event data, to the production line device in a previous stage, the host computer determines that the production efficiency of the production line has decreased, and sets the production line device in a latest stage, which has transmitted the stop request, as the production line device that has caused the decrease in the production efficiency.

With this configuration, when the stop request is transmitted, it is determined that the production efficiency of the production line has decreased, and the production line device at the latest stage, which has transmitted the stop request is set as the production line device that has caused the decrease in the production efficiency. Therefore, it is possible to specify a production line device that has caused the decrease in the production efficiency, which cannot be specified by the production line device that has received the stop request.

Further, in the production management system according to a third aspect of the present invention, in the production management system in the first aspect, when the same event does not occur even after a predetermined time has elapsed from the occurrence of the predetermined event in the production line device, the host computer determines that the production efficiency of the production line has decreased, and sets the production line device as the production line device that has caused the decrease in the production efficiency.

With this configuration, in a production line device that repeats the same processing, if the processing is not performed even after a predetermined time has elapsed, it is determined that the production efficiency has decreased, and the production line device is set as the production line device that has caused the decrease in the production efficiency. Therefore, it is possible to grasp the production line device that has caused the decrease in the production efficiency.

Further, in the production management system according to a fourth aspect of the present invention, in the production management system in the first aspect, when the predetermined event does not occur even after a predetermined time has elapsed in response to a notification of the predetermined event from an adjacent production line device in the production line device, the host computer determines that the production efficiency of the production line has decreased, and sets the production line device as the production line device that has caused the decrease in the production efficiency.

With this configuration, if there is no response to the request signal from the adjacent production line device even after a predetermined time has elapsed, it is determined that the production efficiency has decreased, and the production line device is set as the production line device that has caused the decrease in the production efficiency. Therefore, it is possible to grasp the production line device that has caused the decrease in the production efficiency.

Further, the production management system according to a fifth aspect of the present invention in the production management system in the first aspect further includes a display device that displays predetermined information. After the production line has been operated for a predetermined time, the host computer causes the display device to display the number of requests transmitted from the predetermined production line device to the production line device in a one-previous stage and the number of operations of the production line device in the one-previous stage in the predetermined time, parallel in a graph as a cumulative value per elapsed time.

With this configuration, it is possible to visually grasp a relationship between time transition and production performance, which has difficulty in being grasped during an operation of the production line.

Further, in the production management system according to a sixth aspect of the present invention, in the production management system in the fifth aspect, the host computer identifies and displays a region in the graph in which the production efficiency is decreased, and further displays a reason why the production efficiency is decreased by text information under a condition that an operator enters the identified and displayed region.

With this configuration, it is easy to grasp relevance between transition of production performance and the cause of the decrease in the production efficiency.

In addition, according to a seventh aspect of the present invention, there is provided a production management system that manages a production line for producing a commodity. The production management system includes a plurality of production line devices constituting the production line, and a host computer configured to communicate with the production line devices. In a case where a preset event has occurred, the production line device transmits event data indicating that the event has occurred to the host computer. In a case where the host computer determines that production efficiency of the production line has decreased, based on the received event data, the host computer outputs an alarm.

With this configuration, it is determined whether the production efficiency has decreased, based on the event data transmitted from each production line device, and the alarm is output. Therefore, it is possible to detect that the production efficiency of the entirety of the production line has decreased and issue a warning, before any production line device turns into the abnormal state.

Further, in the production management system according to an eighth aspect of the present invention, in the production management system in the seventh aspect, when the same event does not occur even after a predetermined time has elapsed from the occurrence of the predetermined event in the production line device, the host computer determines that the production efficiency of the production line has decreased.

With this configuration, in a production line device that repeats the same processing, if the processing is not performed even after a predetermined time has elapsed, it is determined that the production efficiency has decreased. Therefore, it is possible to detect and warn that the production efficiency of the entire production line has decreased before any of the production line devices turns into an abnormal state.

Further, in the production management system according to a ninth aspect of the present invention, in the production management system in the seventh aspect, when the predetermined event does not occur even after a predetermined time has elapsed in response to a notification of the predetermined event from an adjacent production line device in the production line device, the host computer determines that the production efficiency of the production line has decreased.

With this configuration, if there is no response to a request signal from the adjacent production line device even after a predetermined time has elapsed, it is determined that the production efficiency has decreased. Therefore, it is possible to detect and warn that the production efficiency of the entire production line has decreased before any of the production line devices turns into the abnormal state.

Further, in the production management system according to a tenth aspect of the present invention, in the production management system in the seventh aspect, the event includes at least a case where processing on a product in the production line device has been ended.

With this configuration, if the processing on the product in the production line device is ended, and thus no more processing is performed even after a predetermined time has elapsed, it is determined that the production efficiency has decreased. Therefore, it is possible to detect and warn that the production efficiency of the entire production line has decreased before any of the production line devices turns into the abnormal state.

Further, the production management system according to an eleventh aspect of the present invention in the production management system in the seventh aspect further includes a display device that displays predetermined information. After the production line has been operated for a predetermined time, the host computer causes the display device to display the number of requests transmitted from the predetermined production line device to the production line device in a one-previous stage and the number of operations of the production line device in the one-previous stage in the predetermined time, parallel in a graph as a cumulative value per elapsed time.

With this configuration, it is possible to visually grasp a relationship between time transition and production performance, which has difficulty in being grasped during an operation of the production line.

Further, in the production management system according to a twelfth aspect of the present invention, in the production management system in the eleventh aspect, the host computer identifies and displays a region in the graph in which the production efficiency is decreased, and further displays a reason why the production efficiency is decreased by text information under a condition that an operator enters the identified and displayed region.

With this configuration, it is easy to grasp relevance between transition of production performance and the cause of the decrease in the production efficiency.

Further, according to a thirteenth aspect of the present invention, there is provided a non-transitory storage medium storing a production management program of a production management system that includes a production line including a plurality of production line devices and a host computer configured to communicate with the production line devices, and in which the production line device transmits event data indicating that a preset event has occurred to the host computer in a case where one or more events have occurred. The production management program causes the host computer to realize a function of specifying, in a case where it is determined that production efficiency of the production line has decreased based on the received event data, the production line device that has caused the decrease in the production efficiency of the production line.

With this configuration, it is determined whether the production efficiency has decreased, based on the event data transmitted from each production line device. In a case where it is determined that the production efficiency has decreased, the production line device that has caused the decrease in the production efficiency is specified. Therefore, it is possible to grasp the production line device that has caused the decrease in the production efficiency.

Further, according to a fourteenth aspect of the present invention, there is provided a non-transitory storage medium storing a production management program of a production management system that includes a production line including a plurality of production line devices and a host computer configured to communicate with the production line devices, and in which the production line device transmits event data indicating that a preset event has occurred to the host computer in a case where the event has occurred. The production management program causes the host computer to realize a function of outputting an alarm to the host computer in a case where it is determined that production efficiency of the production line has decreased based on the received event data.

With this configuration, it is determined whether the production efficiency has decreased, based on the event data transmitted from each production line device, and the alarm is output. Therefore, it is possible to detect and warn that the production efficiency of the entire production line has decreased before any of the production line devices turns into the abnormal state.

### Advantage of the Invention

According to the present invention, it is possible to provide a production management system capable of grasping a production line device that has caused a decrease in production efficiency and notifying an operator that the production efficiency in the entirety of a production line has decreased, before any device reaches an abnormal state.

### BRIEF DESCRIPTION OF THE DRAWINGS

FIG. 1 is a schematic configuration diagram of a production management system according to first and second embodiments of the present invention.

FIG. 2 is a diagram illustrating an example of transmission data of each production line device in the production management system according to the first and second embodiments of the present invention.

FIG. 3 is a sequence diagram illustrating an example in which a stop request signal is transmitted from an inspection device in the production management system according to the first embodiment of the present invention.

FIG. 4 is a sequence diagram illustrating an example in which data transmitted from each production line device in the production management system according to the second embodiment of the present invention is delayed as compared with a case of a normal state.

FIG. 5 is a sequence diagram illustrating an example in which the data transmitted from each production line device in the production management system according to the second embodiment of the present invention differs between adjacent devices.

FIG. 6 is a diagram illustrating an example of a graph of operation performance of the production management system according to the first and second embodiments of the present invention.

### BEST MODE FOR CARRYING OUT THE INVENTION

Hereinafter, a production management system according to embodiments of the present invention will be described in detail with reference to the drawings.

### First Embodiment

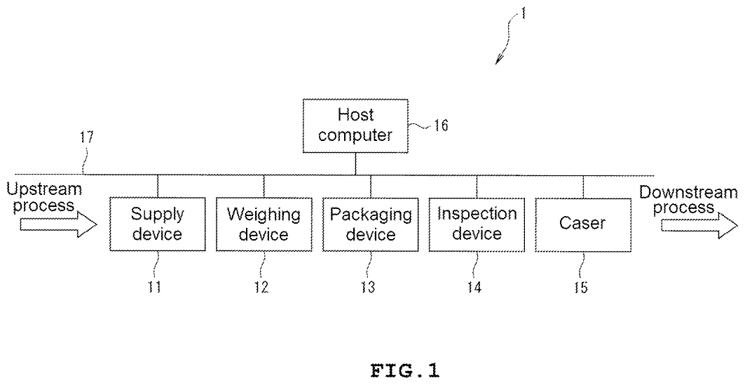

In FIG. 1, a production management system 1 according to a first embodiment of the present invention manages a production line of receiving raw materials such as foods and drinks manufactured and processed in an upstream manufacturing process, packaging the raw materials together in a predetermined weight in a weighing process and a packaging process to obtain a product, inspecting the weight of the product, the presence of foreign matters, a packaging state, and the like in an inspection process, and boxing a product having an inspection result of being determined to be non-defective in a boxing process.

The production line is configured to include a supply device 11, a weighing device 12, a packaging device 13, an inspection device 14, and a caser 15, each of which performs different processing. Each of the devices (11, 12, 13, 14, and 15) is also referred to as a production line device. Usually, the devices (11, 12, 13, 14, and 15) have a form of being arranged and lined up in a series. Transport means such as a belt conveyor is disposed between the front and rear processes in the production line and between the devices in each process.

The present embodiment is not limited to a case where the devices (11 to 15) are arranged to be adjacent to each other as illustrated in FIG. 1. For example, there may be provided a case where the device from the supply device 11 to the packaging device 13 are arranged to be adjacent to each other in a raw material area for handling the raw material before packaging, the inspection device 14 and the caser 15 are arranged to be adjacent to a product area for handling the packaged product, and the divided both areas are joined to each other by transport means including a belt conveyor or a chute.

The supply device 11 receives the raw materials manufactured in the upstream manufacturing process and supplies the raw materials to the weighing device 12 in predetermined amounts.

The weighing device 12 collects or combines the raw materials supplied from the supply device 11 to have a predetermined weight and discharges the resultant to the packaging device 13.

The weighing device 12 may include combined weighing means for temporarily storing the raw material received from the supply device 11 in a storage container, putting the raw material into a plurality of weighing containers by a predetermined amount to be dispersed, combining and calculating the weighed values obtained in each weighing container, and discharging the raw material in a predetermined weight range.

The packaging device 13 packages the raw material of a predetermined weight discharged from the weighing device 12 with a packaging material and discharges the resultant to the inspection device 14.

The inspection device 14 inspects the weight, the presence of foreign matters, and the like of the packaged product discharged from the packaging device 13, and discharges the packaged product determined to be non-defective in the inspection to the caser 15.

The caser 15 packs the packaged product discharged from the inspection device 14 into a box, and then seals and discharges the packaged product to a downstream process.

The host computer 16 is configured by a computer unit including a central processing unit (CPU) (not illustrated), a random access memory (RAM), a read only memory (ROM), a hard disk device, and an input/output port.

The supply device 11, the weighing device 12, the packaging device 13, the inspection device 14, the caser 15, and the host computer 16 are connected to a network 17. The supply device 11, the weighing device 12, the packaging device 13, the inspection device 14, the caser 15, and the host computer 16 can communicate with each other via the network 17.

The arrangement of each device on the production line is preset in the host computer 16, and information regarding other devices arranged in front and rear of one device is stored in association with, for example, an ID unique to the device.

In the example illustrated in FIG. 1, the supply device in the supply process, the weighing device 12 in the weighing process, the packaging device 13 in the packaging process, the inspection device 14 in the inspection process, and the caser 15 in the boxing process are arranged in this order. Such an arrangement is stored in the host computer 16.

In a case where there is a plurality of devices in a certain process, and each of the devices can communicate with the host computer 16, it may be possible to set whether the devices are arranged in series or in parallel.

The host computer 16 receives inspection information (event data) such as inspection results and operation histories transmitted from each device on the production line via the network 17, and stores and manages the inspection information in the hard disk device.

The operation history of the device referred to here is not limited to start and stop of the operation of each device. For example, detection of excess or deficiency in supply amounts of raw materials from the upstream process in the supply device 11, detection of opening of covers, which is caused by the stop of the operation, detection of passage of the raw material discharged by the supply device, and the like are included. Detection of the stored amount of the raw material supplied in the weighing device 12, zero set processing of weighing means (not illustrated), and the like are included. Waiting for the temperature stabilization of a heat seal portion, replacement of a sheet roll of the packaging material, and the like in the packaging device 13 are included. Operation information unique to each device, such as detection of carrying-in of commodities in the inspection device 14, an output of inspection results, reset processing and a stabilization waiting period of inspection means (not illustrated), and out of the packaging material of the caser 15 is included. Such the operation history is transmitted as the event data to the host computer 16.

An ID unique to the device is assigned to the event data, and the ID may be used as identification information for identifying which event data has been transmitted from which device on the data.

Further, the host computer 16 may include reception time-point information adding means for, if receiving the event data transmitted from each device, adding the received time-point information as a time stamp. Thus, even in a case where the event data of any device does not include the time-point information, the time-point information at almost the same time point is recorded in the host computer 16, and thus it is possible to avoid the limit on the functions of control software on the device side. Further, even if there is a deviation in the time point set for each device, the influence is small.

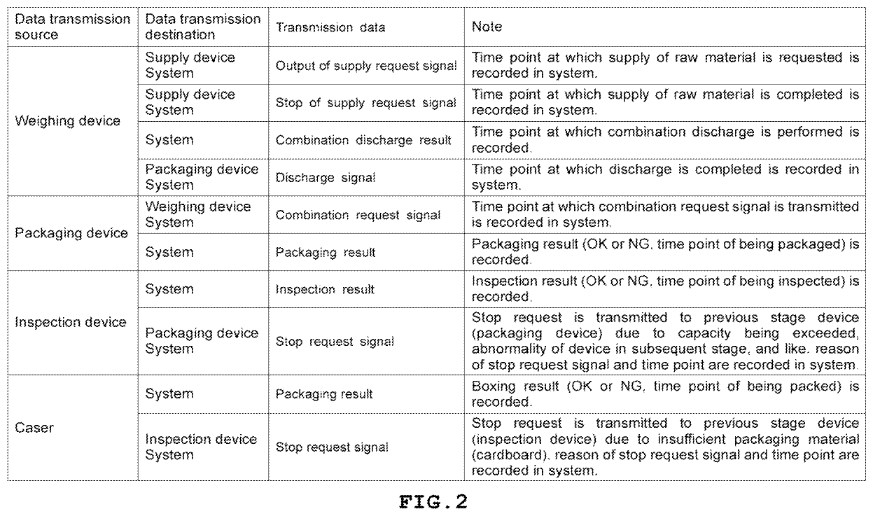

As illustrated in FIG. 2, when a predetermined event has occurred, the weighing device 12, the packaging device 13, the inspection device 14, and the caser 15 transmit transmission data as event data to a data transmission destination. In FIG. 2, a “System” being the data transmission destination means transmission to the host computer 16.

When the weighing device 12 can receive a combination request signal (described later) from the packaging device 13 in the subsequent stage and receive the raw materials, or when it is determined that the received raw materials are insufficient, the weighing device 12 outputs a supply request signal to the supply device 11, and transmits time-point information on a time point at which the supply of the raw material is requested, to the host computer 16 based on the time point at which the weighing device 12 transmits the supply request signal as event data.

When the weighing device 12 determines that the supply of the raw material is sufficient, the weighing device 12 stops the supply request signal output to the supply device 11, and transmits time-point information on a time point at which the supply of the raw material has been completed, to the host computer 16 based on the time point at which the supply request signal is stopped.

The weighing device 12 receives and weighs the raw materials supplied from the supply device 11, collects or combines the raw materials to have a predetermined weight range, and transmits the weighed values of the raw materials to be discharged to the host computer 16.

If the discharge of the raw material is completed, the weighing device 12 transmits a discharge signal to the packaging device 13, and transmits time-point information on a time point at which the discharge is completed, to the host computer 16.

When the packaging device 13 determines that packaging is ready, the packaging device 13 transmits a combination request signal requesting the raw materials to be collected or combined into a predetermined weight to the weighing device 12, and transmits time-point information on a time point at which the combination request signal is transmitted, to the host computer 16.

As a result of packaging, the packaging device 13 transmits a packaging result such as packaging OK (pointing to a normally packaged state) or packaging NG (pointing to a state of being not normally packaged) and time-point data thereof to the host computer 16. The packaging result is also transmitted to the inspection device 14 in the subsequent stage.

The inspection device 14 transmits an inspection result such as inspection OK or inspection NG as a result of inspecting the product, and time-point data on a time point at which the inspection is completed, to the host computer 16. The inspection device 14 may include a distribution device (not illustrated) that excludes the product of the inspection NG and the product receiving the packaging NG from the packaging device 13 out of the production line. Thus, it is possible to discharge only the normal product to the caser 15 in the subsequent stage with high efficiency.

When the inspection device 14 determines that the supply of the product to the caser 15 being the subsequent stage device is stopped due to the processing capacity being exceeded, an abnormality of the device in the subsequent stage, and the like, the inspection device 14 transmits a stop request signal to the packaging device 13 being the previous stage device, and transmits information (reason code) indicating the reason for transmitting the stop request signal and time-point information on a time point at which the stop request signal is transmitted, to the host computer 16.

The caser 15 packs a predetermined number of products received from the inspection device 14 into a box, and transmits, as a result of the boxing, the boxing result such as boxing OK or boxing NG and time-point information on a time point at which the boxing is completed, to the host computer 16.

When the caser 15 determines that the supply of the product is stopped due to a shortage of a packaging materials (for example, cardboard or wrapping sheet), the caser 15 transmits a stop request signal to the inspection device 14 being the previous stage device, and transmits information (reason code) indicating the reason for transmitting the stop request signal and time-point information on a time point at which the stop request signal is transmitted, to the host computer 16.

In the present embodiment, the host computer 16 detects that the production efficiency has decreased, and specifies the device that has caused the decrease in production efficiency, based on pieces of time-point information in transmission data transmitted from the weighing device 12, the packaging device 13, the inspection device 14, and the caser 15.

When the host computer 16 detects that the stop request signal has been transmitted from the subsequent stage device of the production line to the previous stage device, the host computer 16 sets the device in the latest stage, which has transmitted the stop request signal, as the device that has caused the decrease in production efficiency.

For example, when the packaging device 13 receives the stop request signal from the inspection device 14, in the packaging device 13, it is unknown whether the cause of the stoppage occurs in either the inspection device 14 in the first subsequent stage or the caser 15 in the further subsequent stage. However, in the host computer 16, the device that has firstly transmitted the stop request signal can be specified, and thus the device that has caused the decrease in production efficiency can be specified.

Further, in a case where the transmission data transmitted from each device is delayed compared to a normal state, the host computer 16 uses the device as the device that has caused the decrease in production efficiency.

For example, in a case where the inspection device 14 receives the product from the packaging device 13 (receives the packaging result) and no inspection result is obtained even after a predetermined time has elapsed, the host computer 16 sets the inspection device 14 as the device that has caused the decrease in production efficiency.

Further, in a case where processing corresponding to a notification of the transmission data from the adjacent device is delayed in each device, the host computer 16 uses the device as the device that has caused the decrease in production efficiency.

For example, in a case where a combination discharge signal is not transmitted from the weighing device 12 even after a predetermined time has elapsed after the combination request signal is transmitted from the packaging device 13, the host computer 16 sets the weighing device 12 as the device that has caused the decrease in production efficiency.

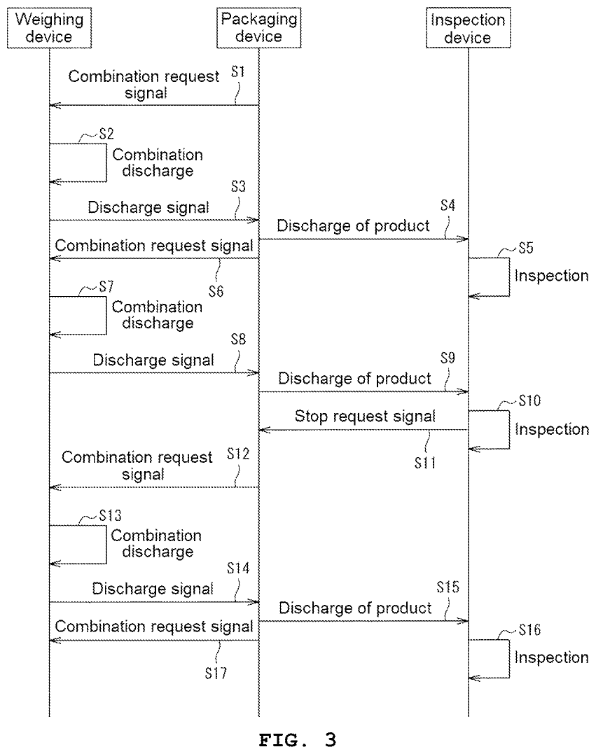

For example, in a case illustrated in FIG. 3, in Step S1, the packaging device 13 transmits a combination request signal to the weighing device 12 when the packaging is ready.

In Step S2, the weighing device 12 collects or combines the raw materials so as to have a predetermined weight and discharges the raw materials to the packaging device 13. In Step S3, a discharge signal is transmitted to the packaging device 13.

In Step S4, the packaging device 13 packages the raw materials discharged from the weighing device 12 and discharges the resultant as a product to the inspection device 14.

In Step S5, the inspection device 14 inspects the product discharged from the packaging device 13.

In Step S6, the packaging device 13 transmits a combination request signal to the weighing device 12 when the discharge of the product is completed, and the next packaging is ready.

In Step S7, the weighing device 12 collects or combines the raw materials so as to have a predetermined weight and discharges the raw materials to the packaging device 13. In Step S8, the discharge signal is transmitted to the packaging device 13.

In Step S9, the packaging device 13 packages the raw materials discharged from the weighing device 12 and discharges the resultant as a product to the inspection device 14.

In Step S10, the inspection device 14 inspects the product discharged from the packaging device 13.

At this time, due to the capacity of the inspection device 14 being exceeded or the like, in Step S11, the inspection device 14 transmits a stop request signal to the packaging device 13.

In such a case, the packaging device 13 does not know whether the cause is the inspection device 14 or the caser 15 being the subsequent stage device. However, since the host computer 16 receives only the stop request signal from the inspection device 14, it is possible to specify the cause of the decrease in production efficiency as being the inspection device 14.

Then, in Step S12, the packaging device 13 transmits a combination request signal to the weighing device 12 when the discharge of the product is completed, and the next packaging is ready.

Here, in the weighing device 12, it is not possible to perform the combination and discharge due to insufficient supply of raw materials, and the like. If a predetermined time has elapsed, the host computer 16 sets the cause of the decrease in production efficiency as being the weighing device 12.

Then, in Step S13, the weighing device 12 collects or combines the raw materials so as to have a predetermined weight and discharges the raw materials to the packaging device 13. In Step S14, the discharge signal is transmitted to the packaging device 13.

In Step S15, the packaging device 13 packages the raw materials discharged from the weighing device 12 and discharges the resultant as a product to the inspection device 14.

In Step S16, the inspection device 14 inspects the product discharged from the packaging device 13.

In Step S17, the packaging device 13 transmits a combination request signal to the weighing device 12 when the discharge of the product is completed, and the next packaging is ready.

In the host computer 16, for example, after the production of one day is finished, the operation performance of one day can be displayed on the display device.

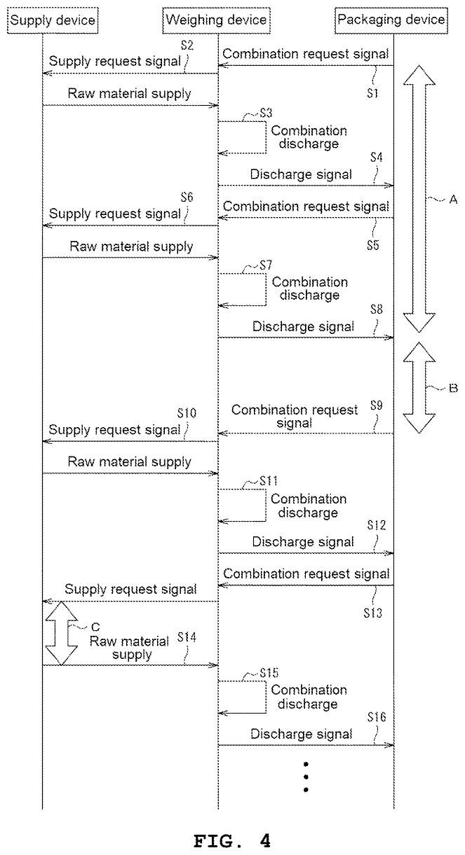

As illustrated in FIG. 4, for example, the host computer 16 displays, in a graph, a relationship between the elapsed time from the start of production, and the combination request number NA being the number of combination request signals transmitted from the packaging device 13 to the weighing device 12 and the combination discharge number NB being the number of raw materials discharged from the weighing device 12 to the packaging device 13. Thus, it is possible to visually grasp the relationship between the time transition and production performance, which has difficulty in being grasped during the operation of the production line, and to utilize the relation in the next improvement of production efficiency. In addition, it is possible to save the relation as a portion of the so-called daily production report and compare the relation with the previous performance or with the performance between a plurality of production lines.

Further, the host computer 16 visually identifies and displays a portion of the graph in which the production efficiency has decreased based on the combination request number NA and the combination discharge number NB, for example, by color-coding or by zoning like circled.

For example, when an operator such as a mouse cursor is placed on a portion surrounded by a circle due to a decrease in production efficiency, the host computer 16 displays the cause of the decrease in production efficiency in a message area near a graph display area. When a pop-up is displayed on the graph display area, it is easy to grasp the relevance between the transition of production performance and the cause of the decrease in production efficiency.

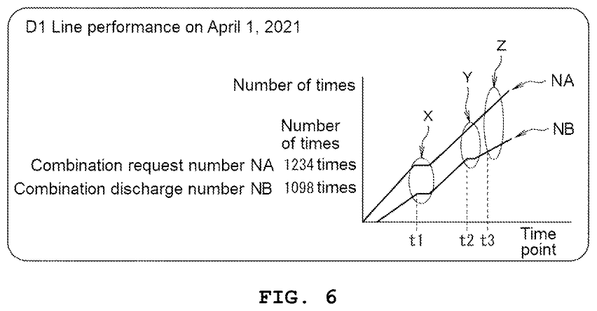

In FIG. 6, when the mouse cursor is placed on the circled zone indicated by X, the host computer 16 can display the sentence meaning the cause that both the combination request number NA and the combination discharge number NB from a time point t1 are not increasing. Thus, for example, if data of the stop request signal is recorded in reception data from the inspection device 14 at a time point near the time point t1, “the operating rate has decreased due to a production stop command from the subsequent stage device” and the like are displayed.

When the mouse cursor is placed on the circled zone indicated by Y, the host computer 16 can display the sentence meaning the cause that the combination discharge number NB from a time point t2 is not increasing. Thus, for example, if an ON state of the supply request signal from the weighing device 12 is continuously recorded at a time point near the time point t2, or an OFF state of the supply request signal is not recorded, “continuous output of supply request signal”, “insufficient supply amount”, “the operating rate has decreased due to the insufficient supply amount”, and the like are displayed.

When the mouse cursor is placed on the circled zone indicated by Z, the host computer 16 can display the sentence meaning the cause that the increase rate of the combination discharge number NB, that is, the slope of the graph near a time point t3 is small even though another piece of event data related to the efficiency decrease is not recorded near the time point t3. In such case, there is a high probability that the cause is the transfer between or within the processes in the packaging area for handling the raw materials that have variable factors and need to be adjusted in the production line. Thus, for example, if the number of packaging results of the packaging device 13 is small, “the operating rate has decreased due to the weighing product bridge” and the like are displayed.

As described above, in the first embodiment, the host computer 16 detects that the production efficiency has decreased and specifies the device that has caused the decrease in production efficiency, based on the event data transmitted from the weighing device 12, the packaging device 13, the inspection device 14, and the caser 15.

Thus, when it is detected, from the event data transmitted from each device, that the production efficiency has decreased, the device that has caused the decrease in the production efficiency is specified, and thus it is possible to grasp the device that has caused the decrease in the production efficiency.

Further, in a case where the stop request is transmitted to the previous stage device by each device, the host computer 16 sets the device in the latest stage, which has transmitted the stop request, as the device that has caused the decrease in production efficiency.

As a result, it is possible to specify the device that has caused the decrease in production efficiency, which cannot be specified by the device that has received the stop request.

Further, the host computer 16 determines that the production efficiency has decreased when the same event does not occur even after a predetermined time elapses after the occurrence of a predetermined event in each device and sets this device as the device that has caused the decrease in the production efficiency.

Thus, in the device that repeats the same processing, if the processing is not performed even after a predetermined time has elapsed, it is determined that the production efficiency has decreased, and this device is set as the device that has caused the decrease in production efficiency. This makes it possible to specify the device that has caused the decrease in the production efficiency.

Further, the host computer 16 determines that the production efficiency of each device has decreased when a predetermined event does not occur even after a predetermined time has elapsed in response to the notification of the predetermined event from the adjacent device on the line and sets this device as the device that has caused the decrease in production efficiency.

Thus, for example, if the combination request signal is not transmitted from the packaging device 13 even after a predetermined time has elapsed after the combination discharge signal is transmitted from the weighing device 12, it is determined that the production efficiency has decreased, and the packaging device 13 is set as the device that has caused the decrease in production efficiency. This makes it possible to specify the device that has caused the decrease in the production efficiency.

### Second Embodiment

A production management system 1 according to a second embodiment of the present invention has the same basic configuration as the production management system according to the first embodiment. The schematic configuration illustrated in FIG. 1, the transmission data illustrated in FIG. 2, the basic operation of each of the devices 11 to 16, and the like are the same as those in the first embodiment.

In the second embodiment, the host computer 16 detects that the production efficiency in the entirety of the production line has decreased, based on pieces of time-point information in data transmitted from the weighing device 12, the packaging device 13, the inspection device 14, and the caser 15, and then outputs an alarm. Regarding the alarm output, for example, a message is output to a display device (not illustrated) connected to the host computer 16, or a visually or audibly identifiable form is output on a production status monitor appropriately provided near the production line.

In a case where the data transmitted from each device is delayed as compared with the normal state, the host computer 16 determines that the production efficiency of the entirety of the production line has decreased. In other words, in a case where the data transmitted from each device is delayed compared to the normal state, the host computer specifies the delayed device among the devices and determines that the production efficiency in the entirety of the production line has decreased. Then, the host computer 16 outputs an alarm. In a case where there is an event that is delayed compared to the normal state, each device itself may issue an alarm.

The “normal state” here is not limited to a case where each device on the production line operates without becoming an abnormal state and refers to a case where the operating rate of the entirety of the production line is maintained to be equal to or more than a predetermined standard value. Specifically, the normal state refers to a case where each device operates in cooperation with a preset reference sequence based on the data transmitted from each device of the production line to the host computer 16.

The host computer 16 stores a reference sequence set according to the functions of the devices constituting the production line and the arrangement in the production line.

The host computer 16 may store a plurality of reference sequences such as sequences SQ1, SQ2, and so on for each production line or according to the target production efficiency of a certain production line so that the reference sequences can be switched.

Further, when one device outputs a signal to other devices, a signal having the same content is also output to the host computer 16. For example, in a case where a level signal in which the request signal ON is at a high level and the request signal OFF is at a low level is output from one device to another device, an analog input port (not illustrated) may be assigned to the host computer 16 or a data signal may be transmitted from another device on the reception side via the network 17.

For example, in the case illustrated in FIG. 4, the arrow portion indicated by A is the normal state. In Step S1, the packaging device 13 transmits a combination request signal to the weighing device 12 when the packaging is ready.

When a supply request signal is transmitted from the weighing device 12 to the supply device 11, and a raw material is supplied from the supply device 11 to the weighing device 12, in Step S2, the weighing device 12 collects or combines the raw materials so as to have a predetermined weight and discharges the raw materials to the packaging device 13 in Step S3. In Step S4, a discharge signal is transmitted to the packaging device 13.

In Step S2, the supply device 11 may operate so as to supply a predetermined amount at a predetermined interval even if the supply request signal is not transmitted from the weighing device 12. In this case, the weighing device 11 outputs a supply stop signal to the supply device 11 so as not to receive more raw materials than necessary from the supply device 11. As a result, the raw material does not stay in the weighing device 11 or become agglomerated and clogged.

In Step S5, the packaging device 13 transmits a combination request signal to the weighing device 12 when the packaging is completed, and the next packaging is ready.

When a supply request signal is transmitted from the weighing device 12 to the supply device 11, and a raw material is supplied from the supply device 11 to the weighing device 12, in Step S6, the weighing device 12 collects or combines the raw materials so as to have a predetermined weight and discharges the raw materials to the packaging device 13 in Step S7. In Step S8, a discharge signal is transmitted to the packaging device 13.

Here, as shown by the arrow indicated by B, in a case where the combination request signal from the packaging device 13 in Step S9 is delayed even by a small amount of time, the production efficiency of the entirety of the production line has decreased.

The host computer 16 outputs an alarm in a case where the combination request signal is not transmitted from the packaging device 13 even after a predetermined time has elapsed from transmission of the discharge signal from the weighing device 12. In a case where the combination request signal is not transmitted from the packaging device 13 even after a predetermined time has elapsed from transmission of the discharge signal in the weighing device 12, the weighing device 12 may output an alarm.

Then, when a supply request signal is transmitted from the weighing device 12 to the supply device 11, and a raw material is supplied from the supply device 11 to the weighing device 12, in Step S10, the weighing device 12 combines the raw materials so as to have a predetermined weight and discharges the raw materials to the packaging device 13 in Step S11. In Step S12, a discharge signal is transmitted to the packaging device 13.

In Step S13, the packaging device 13 transmits a combination request signal to the weighing device 12 when the packaging is completed, and the next packaging is ready. Then, the weighing device 12 transmits a supply request signal to the supply device 11.

Here, in a case where the supply of raw materials from the supply device 11 in Step S14 is delayed as shown by the arrow indicated by C, the discharge of the combination of the weighing devices 12 in Step S15 and the transmission of the combination discharge signal in Step S16 are also delayed. Thus, the production efficiency decreases.

The host computer 16 outputs an alarm in a case where the combination discharge result or the discharge signal is not transmitted from the weighing device 12 even after a predetermined time has elapsed from the transmission of the combination request signal from the packaging device 13. In a case where the discharge signal is not transmitted from the weighing device 12 even after a predetermined time has elapsed from transmission of the combination request signal in the packaging device 13, the packaging device 13 may output an alarm.

Further, the host computer 16 determines that the production efficiency has decreased in a case where the data transmitted from each device has a difference in the signal transmission order between the adjacent devices so as to be different from the predetermined sequence.

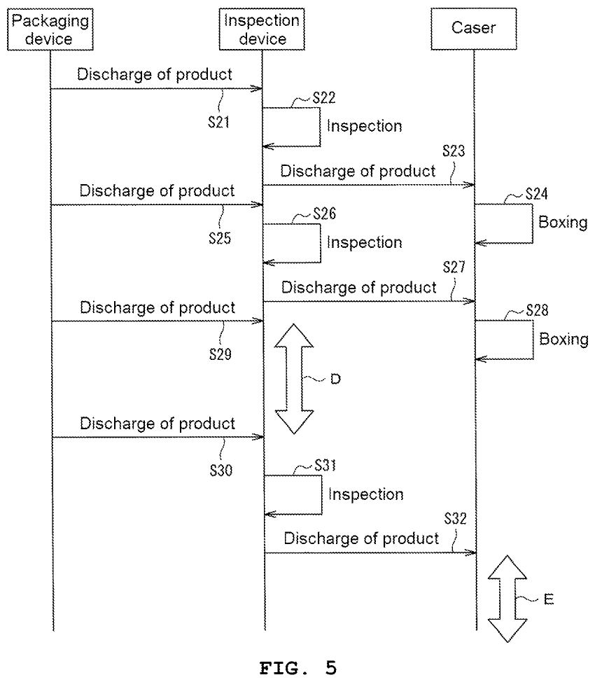

For example, in the case illustrated in FIG. 5, in Step S21, the packaging device 13 discharges the packaged product to the inspection device 14. In Step S22, the inspection device 14 inspects the product. In Step S23, the inspection device 14 discharges the product determined to be non-defective. In Step S24, the caser 15 packs the product in a box, and then seals and discharges the product.

Here, since the inspection device 14 can perform the inspection in a time shorter than the operation interval of the packaging device 13, the signal requesting the discharge of the product is not transmitted to the packaging device 13 in the previous stage. That is, the packaging device 13 discharges the packaged product to the inspection device 14 without receiving the signal from the inspection device 14 in the subsequent stage, and similarly, the inspection device does not receive the signal from the caser 15 and discharges the product determined to be non-defective to the caser 15.

Then, in Step S25, the packaging device 13 discharges the packaged product to the inspection device 14. In Step S26, the inspection device 14 inspects the product. In Step S27, the inspection device 14 discharges the product determined to be non-defective. In Step S28, the caser 15 packs the product in a box, and then seals and discharges the product.

Here, in Step S29, in a case where the discharge of the product from the packaging device 13 of the inspection result in the inspection device 14 is not transmitted during a period of the arrow indicated by D after the packaging device 13 discharges the packaged product to the inspection device 14, the production efficiency decreases.

In a case where the host computer 16 does not receive the inspection result from the inspection device 14 or the packaging result from the packaging device 13 even after a predetermined time has elapsed from reception of the packaging result from the packaging device 13, it is determined that the production efficiency has decreased by an occurrence of failure of the production of the product, or the conveyance failure between the adjacent conveyors in the line, and outputs an alarm.

Then, in Step S30, the packaging device 13 discharges the packaged product to the inspection device 14. In Step S31, the inspection device 14 inspects the product. In Step S32, the inspection device 14 discharges the product determined to be non-defective.

Here, as shown by the arrow indicated by E, in a case where the discharge of the product from the inspection device 14 or the boxing in the caser 15 is not performed even after a predetermined time has elapsed after the inspection device 14 discharges the product in Step S32, the product is not discharged from the boxing process to the downstream process, and thus the production efficiency decreases.

In a case where the host computer 16 does not receive the packaging result from the caser 15 or the inspection result from the inspection device 14 even after a predetermined time has elapsed from reception of the inspection result from the inspection device 14, it is determined that the production efficiency has decreased by an occurrence of failure of the production of the product, or the conveyance failure between the adjacent conveyors in the line, and outputs an alarm.

In the host computer 16, for example, after the production of one day is finished, the operation performance of one day can be displayed on the display device.

As illustrated in FIG. 6, for example, the host computer 16 displays, in a graph, a relationship between the elapsed time from the start of production, and the combination request number NA being the number of combination request signals transmitted from the packaging device 13 to the weighing device 12 and the combination discharge number NB being the number of raw materials discharged from the weighing device 12 to the packaging device 13. Thus, it is possible to visually grasp the relationship between the time transition and production performance, which has difficulty in being grasped during the operation of the production line, and to utilize the relation in the next improvement of production efficiency. In addition, it is possible to save the relation as a portion of the so-called daily production report and compare the relation with the previous performance or with the performance between a plurality of production lines.

Further, the host computer 16 visually identifies and displays a portion of the graph in which the production efficiency has decreased based on the combination request number NA and the combination discharge number NB, for example, by color-coding or by zoning like circled.

For example, when an operator, namely a symbol for pointing a certain position such as a mouse cursor is placed on a portion surrounded by a circle due to a decrease in production efficiency, the host computer 16 displays the cause of the decrease in production efficiency in a message area near a graph display area. When a pop-up is displayed on the graph display area, it is easy to grasp the relevance between the transition of production performance and the cause of the decrease in production efficiency.

In FIG. 6, when the mouse cursor is placed on the circled zone indicated by X, the host computer 16 can display the sentence meaning the cause that both the combination request number NA and the combination discharge number NB from a time point t1 are not increasing. Thus, for example, if data of replacement of the packaging material is recorded in reception data from the packaging device 13 at the time point near the time point t1, “replacement of the packaging material”, “the operation has decreased due to the replacement of the packaging material”, and the like are displayed.

When the mouse cursor is placed on the circled zone indicated by Y, the host computer 16 can display the sentence meaning the cause that the combination discharge number NB from a time point t2 is not increasing. Thus, for example, if the ON sate of the supply request signal from the weighing device 12 is continuously recorded at a time point near the time point t2, or the OFF state of the supply request signal is not recorded, “continuous output of supply request signal”, “insufficient supply amount”, “the operating rate has decreased due to the insufficient supply amount”, and the like are displayed.

When the mouse cursor is placed on the circled zone indicated by Z, the host computer 16 can display the sentence meaning the cause that the increase rate of the combination discharge number NB, that is, the slope of the graph near a time point t3 is small even though another piece of event data related to the efficiency decrease is not recorded near the time point t3. In such case, there is a high probability that the cause is the transfer between or within the processes in the packaging area for handling the raw materials that have variable factors and need to be adjusted in the production line. Thus, for example, if the number of packaging results of the packaging device 13 is small, “the operating rate has decreased due to the weighing product bridge” and the like are displayed.

As described above, in the second embodiment, the host computer 16 detects that the production efficiency has decreased, based on pieces of the event data transmitted from the weighing device 12, the packaging device 13, the inspection device 14, and the caser 15, and then outputs an alarm.

Thus, when it is detected that the production efficiency has decreased based on the event data transmitted from each device, an alarm is output, and thus it is possible to detect that the production efficiency has decreased, before the abnormal state occurs, and issue a warning.

Further, the host computer 16 determines that the production efficiency has decreased when the same event does not occur even after a predetermined time has elapsed from the occurrence of the predetermined event in each device.

Thus, it is possible to detect that the production efficiency has decreased when the processing is not performed even after a predetermined time has elapsed in the device that repeats the same processing, and to detect that the production efficiency has decreased, before the abnormal state occurs, and issue a warning.

Further, the host computer 16 determines that the production efficiency has decreased when a predetermined event does not occur even after a predetermined time has elapsed in response to the notification of the predetermined event from the adjacent device on the production line.

As a result, for example, it is possible to detect that the production efficiency has decreased when the combination request signal is not transmitted from the packaging device 13 even after a predetermined time has elapsed after the combination discharge signal is transmitted from the weighing device 12. Thus, it is possible to detect that the production efficiency has decreased, before the abnormal state occurs, and issue a warning.

The case where the alarm and the graph of the operation performance are displayed on the display device of the host computer 16 has been described in the first and second embodiments, but the information may be transmitted to an information device such as a tablet terminal connected to the network 17 and displayed.

Hitherto, the first and second embodiments of the present invention have been disclosed, but it is clear that changes can be made by those skilled in the art without departing from the scope of the present invention. All such modifications and equivalents are intended to be included in the claims.

### DESCRIPTION OF REFERENCE NUMERALS AND SIGNS

1 PRODUCTION MANAGEMENT SYSTEM
11 SUPPLY DEVICE (PRODUCTION LINE DEVICE IN SUPPLY PROCESS)
12 WEIGHING DEVICE (PRODUCTION LINE DEVICE IN WEIGHING PROCESS)
13 PACKAGING DEVICE (PRODUCTION LINE DEVICE IN PACKAGING PROCESS)
14 INSPECTION DEVICE (PRODUCTION LINE DEVICE IN INSPECTION PROCESS)
15 CASER (PRODUCTION LINE DEVICE IN BOXING PROCESS)
16 HOST COMPUTER
17 NETWORK

What is claimed is:

1. A production management system that manages a production line for producing a commodity, the system comprising:
a plurality of production line devices constituting the production line; and
a host computer configured to communicate with the production line devices,
wherein, in a case where a preset event has occurred, the production line device transmits event data indicating that the event has occurred to the host computer, and
in a case where the host computer determines that production efficiency of the production line has decreased, based on the received event data, the host computer specifies the production line device that has caused the decrease in the production efficiency of the production line.

2. The production management system according to claim 1, wherein
in a case where a predetermined production line device transmits a stop request, as the event data, to the production line device in a previous stage,
the host computer determines that the production efficiency of the production line has decreased, and sets the production line device in a latest stage, which has transmitted the stop request, as the production line device that has caused the decrease in the production efficiency.

3. The production management system according to claim 1, wherein
when the same event does not occur even after a predetermined time has elapsed from the occurrence of the predetermined event in the production line device,
the host computer determines that the production efficiency of the production line has decreased, and sets the production line device as the production line device that has caused the decrease in the production efficiency.

4. The production management system according to claim 1, wherein
when the predetermined event does not occur even after a predetermined time has elapsed in response to a notification of the predetermined event from an adjacent production line device in the production line device,
the host computer determines that the production efficiency of the production line has decreased, and sets the production line device as the production line device that has caused the decrease in the production efficiency.

5. The production management system according to claim 1, further comprising:
a display device that displays predetermined information,
wherein, after the production line has been operated for a predetermined time,
the host computer causes the display device to display the number of requests transmitted from the predetermined production line device to the production line device in a one-previous stage and the number of operations of the production line device in the one-previous stage in the predetermined time, parallel in a graph as a cumulative value per elapsed time.

6. The production management system according to claim 5, wherein
the host computer identifies and displays a region in the graph in which the production efficiency is decreased, and further displays a reason why the production efficiency is decreased by text information under a condition that an operator enters the identified and displayed region.

7. A production management system that manages a production line for producing a commodity, the system comprising:
a plurality of production line devices constituting the production line; and
a host computer configured to communicate with the production line devices,
wherein, in a case where a preset event has occurred, the production line device transmits event data indicating that the event has occurred to the host computer, and
in a case where the host computer determines that production efficiency of the production line has decreased, based on the received event data, the host computer outputs an alarm.

8. The production management system according to claim 7, wherein
when the same event does not occur even after a predetermined time has elapsed from the occurrence of the predetermined event in the production line device, the host computer determines that the production efficiency of the production line has decreased.

9. The production management system according to claim 7, wherein
when the predetermined event does not occur even after a predetermined time has elapsed in response to a notification of the predetermined event from an adjacent production line device in the production line device, the host computer determines that the production efficiency of the production line has decreased.

10. The production management system according to claim 7, wherein
the event includes at least a case where processing on a product in the production line device has been ended.

11. The production management system according to claim 7, further comprising:
a display device that displays predetermined information,
wherein, after the production line has been operated for a predetermined time,
the host computer causes the display device to display the number of requests transmitted from a predetermined production line device to the production line device in a one-previous stage and the number of operations of the production line device in the one-previous stage in the predetermined time, parallel in a graph as a cumulative value per elapsed time.

12. The production management system according to claim 11,
wherein the host computer identifies and displays a region in the graph in which the production efficiency is decreased, and further displays a reason why the production efficiency is decreased by text information under a condition that an operator enters the identified and displayed region.

13. A non-transitory storage medium storing a production management program of a production management system that includes a production line including a plurality of production line devices and a host computer configured to communicate with the production line devices, and in which the production line device transmits event data indicating that a preset event has occurred to the host computer in a case where the event has occurred, the program causing the host computer to realize:
a function of specifying, in a case where it is determined that production efficiency of the production line has decreased based on the received event data, the production line device that has caused the decrease in the production efficiency of the production line.

14. A non-transitory storage medium storing a production management program of a production management system that includes a production line including a plurality of production line devices and a host computer configured to communicate with the production line devices, and in which the production line device transmits event data indicating that a preset event has occurred to the host computer in a case where the event has occurred, the program causing the host computer to realize:
a function of outputting an alarm to the host computer in a case where it is determined that production efficiency of the production line has decreased based on the received event data.
